(19) United States
(12) Patent Application Publication
(10) Pub. No.: US 2024/0017099 A1
(43) Pub. Date: Jan. 18, 2024

(54) MASK

(71) Applicant: AMOLIFESCIENCE CO., LTD., Seoul (KR)

(72) Inventor: Jeong Su SEOK, Seoul (KR)

(21) Appl. No.: 18/044,553

(22) PCT Filed: Sep. 1, 2021
(86) PCT No.: PCT/KR2021/011757

§ 371 Date: Mar. 8, 2023

(30) Foreign Application Priority Data
Sep. 18, 2020 (KR) 10-2020-0120233

(51) Int. Cl. A62B 23/02; A41D 13/11; D02G 3/12; D03D 1/00; D03D 15/258; D03D 15/292; D04H 3/16; D04H 1/56; B01D 39/16; A62B 18/08

(52) U.S. Cl. CPC A62B 23/025; A41D 13/1161; A41D 13/113; D02G 3/12; D03D 1/0035; D03D 15/258; D03D 15/292; D04H 3/16; D04H 1/56; B01D 39/1623; A62B 18/084; A41D 2400/38; A41D 2500/20; A41D 2300/20; A41D 2500/30; D10B 2401/022; D10B 2509/00; B01D 2239/0627; B01D 2239/0622; B01D 2239/0654; B01D 2239/025; B01D 2239/0435

(57) ABSTRACT

A mask is provided. The mask according to an embodiment of the present invention comprises: an outer skin which forms an externally exposed surface when the mask is worn; an inner skin fixed to one surface of the outer skin so that an accommodation portion having at least one side open is formed between the outer skin and one surface of the inner skin facing the outer skin while the inner skin is in close contact with a user's face part when the mask is worn; a filter medium accommodated in the accommodation portion; and wearing portions provided on both sides of the outer skin to be respectively worn on the user's ears.

### TECHNICAL FIELD

The present invention relates to a mask.

### BACKGROUND ART

Generally, masks are items for blocking cold or preventing inhalation of dust, droplets, and the like in the air.

In such a mask, since a filter medium for preventing inhalation of dust, droplets, and the like in the air is generally integrally formed with the mask, there is a problem that filtration efficiency is reduced or the function of the mask is not accomplished when the mask is reused.

In addition, there are numerous pathogens such as bacteria, fungi, and viruses which directly harm the human body in the air in addition to dust, and diseases may be caused when the pathogens are inhaled into the human body through breathing.

In order to address this problem, antimicrobial masks are being developed.

However, antimicrobial masks have problems of a bad smell, side effects on skin when worn for a long time, and a decrease in antibacterial performance after washing.

In addition, in the case of a conventional general mask, there is a problem that the mask needs to be replaced with a new mask due to a bad smell because the mask is contaminated through bacteria in the mouth when the mask is worn for a long time.

Accordingly, there is an urgent need to develop a mask which can fundamentally prevent generation of bacteria due to a user's saliva and re-inhalation of proliferated bacteria and can also be repeatedly reused.

### Technical Problem

The present invention is intended to address the problems described above and directed to providing a mask which has superior filtration efficiency and can also be reused.

The present invention is also directed to providing a mask capable of fundamentally preventing generation of bacteria due to a user's saliva and preventing re-inhalation of proliferated bacteria.

### Technical Solution

One aspect of the present invention provides a mask including an outer skin which constitutes an outer exposed surface when the mask is worn, an inner skin which is in contact with the face of a user and is fixed to one surface of the outer skin so that an accommodation portion of which at least one side is open is formed between one surface of the inner skin facing the outer skin and the outer skin, a filter medium accommodated in the accommodation portion, and a wearing portion provided at each of both side portions of the outer skin for the mask to be worn on ears of the user.

The inner skin may include a pair of a first inner skin and a second inner skin connected to each other through a sewing member and disposed at both of a left side and a right side of the sewing member, and the mask may further include a shape-retaining member embedded in the sewing member so that a space between a mouth and a nose of the user is maintained by maintaining a shape of the sewing member when the mask is worn.

The shape-retaining member may be a plate member or linear wire, and the plate member or linear wire may be formed of a metal material or synthetic resin material.

The inner skin may be a woven fabric having a warp and a weft, at least a part of the warp may be a ply yarn including a silver yarn, and the ply yarn may be provided in one surface of the inner skin facing the outer skin to be exposed.

The ply yarn may include a core yarn, a first covering yarn including a silver yarn and wound around the core yarn in a longitudinal direction of the core yarn, and a second covering yarn wound around the first covering yarn in the longitudinal direction of the core yarn to surround the first covering yarn, and each of the core yarn and the second covering yarn may be a natural fiber or synthetic fiber.

The inner skin may include at least one reinforcement member fixed to one surface of the inner skin facing the outer skin, and the at least one reinforcement member may be disposed to intersect the warp to maintain an original shape of the inner skin.

The silver yarn may include a sheath-core fiber having a core including copper and a sheath including silver and surrounding the core.

The mask may further include an edge member sealed along an edge of the outer skin, wherein the edge member may be a band member having elasticity and flexibility.

In this case, the wearing portion may be formed by extending a part of the edge member outwardly from the outer skin.

The inner skin may be fixed to the outer skin through the edge member.

The mask may further include a nose rest member extending from the outer skin to be in close contact with the nose of the user when the mask is worn and a jaw rest member extending from the outer skin to be in close contact with the jaw of the user when the mask is worn, wherein the jaw rest member may be provided to have a larger area than the nose rest member.

The filter medium may have a form in which a porous first support, a porous second support, and a nanofiber web are sequentially stacked.

The first support may be a spunbond nonwoven fabric, and the second support may be a meltblown nonwoven fabric.

The first support may be a water-repellent/oil-repellent spunbond nonwoven fabric, and the nanofiber web may be a water-repellent/oil-repellent nanofiber web.

The second support may include an electrostatically treated portion.

### Advantageous Effects

According to the present invention, since a filter medium is removably inserted into an accommodation portion, a mask can be reused by simply replacing only the filter medium.

According to the present invention, since an inner skin includes a ply yarn having a silver yarn, generation of bacteria due to a user's saliva and re-inhalation of proliferated bacteria can be fundamentally prevented to improve antibacterial performance.

### DESCRIPTION OF DRAWINGS

FIG. 1 is a view illustrating a mask according to one embodiment of the present invention.

FIG. 2 is a rear view of FIG. 1.

FIG. 3 is a side view of FIG. 1.

FIG. 4 is an exploded view of FIG. 1.

FIG. 5 is a view illustrating a state in which an inner skin is removed in FIG. 2.

FIG. 6 is a view illustrating the inner skin separated from FIG. 2 and an opposite surface of FIG. 2.

FIG. 7 is a cross-sectional view illustrating a detailed structure of a filter medium which may be applied to the mask according to one embodiment of the present invention.

FIG. 8 is a view illustrating a use state of the mask according to one embodiment of the present invention.

### MODES OF THE INVENTION

Herein, embodiments that are easily performed by those skilled in the art will be described in detail with reference to the accompanying drawings. The present invention may be implemented in several different forms, and is not limited to the embodiments described herein. Parts irrelevant to description will be omitted in the drawings in order to clearly describe the embodiments of the present invention. Identical or similar parts will be denoted by the same reference numerals throughout this specification.

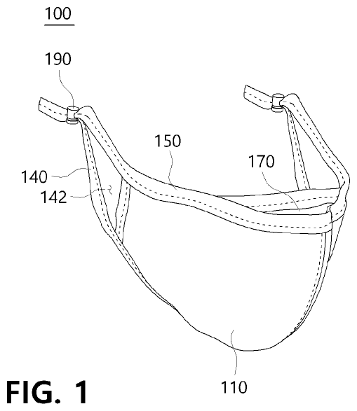

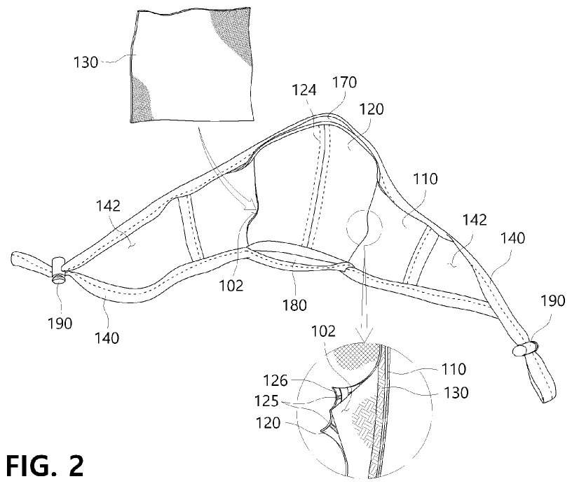

As illustrated in FIGS. 1 and 2, a mask 100 according to one embodiment of the present invention includes an outer skin 110, an inner skin 120, a filter medium 130, and a wearing portion 140 and may be worn on a user's ears using the wearing portion 140 as illustrated in FIG. 8.

The outer skin 110 may constitute an outer exposed surface exposed to the outside without coming into direct contact with the user's face when worn.

The outer skin 110 may have hydrophobicity, quick-drying, and water-repellent properties in order to prevent generation of bacteria and proliferation of bacteria due to external water, moisture, and the user's saliva.

As an example, the outer skin 110 may be formed of a natural fiber, a synthetic fiber, or the like.

As a non-limiting example, the natural fiber may be a fiber formed of any one of Korean paper (Hanji), poly lactic acid (PLA, a biodegradable fiber), cotton, hemp, hair, and silk, and the synthetic fiber may be a fiber formed of any one of a nylon-based fiber, a polyester-based fiber, a polyvinyl chloride-based fiber, a polyacrylonitrile-based fiber, a polyamide-based fiber, a polyolefin-based fiber, a polyurethane-based fiber, and a polyfluoroethylene-based fiber. In addition, a fiber obtained using the following polymers may be used as the synthetic fibers.
a polyethylene-based resin such as a low-density polyethylene resin (LDPE), an ultra-low-density polyethylene resin (LLDPE), a high-density polyethylene (HDPE), an ethylene-vinyl acetate resin (EVA), a copolymer thereof, or the like
a polystyrene-based resin such as high impact polystyrene (HIPS), geranyl pyrophosphate synthase (GPPS), styrene acrylonitrile (SAN), or the like
a polypropylene-based resin such as homo polypropylene (PP), random PP, or a copolymer thereof
a transparent or regular acrylonitrile-butadiene-styrene (ABS) ternary copolymer
rigid polyvinyl chloride (PVC)
an engineering plastic such as nylon, PRT, polyethylene terephthalate (PET), polyoxymethylene (POM, acetal), polycarbonate (PC), urethane, a powder resin, poly methyl methacrylate (PMMA), polyethersulfone (PES), or the like

In addition, any well-known fiber in addition to the above-described fiber materials may be used as the natural fiber or synthetic fiber.

However, a material of the outer skin 110 is not limited thereto, and any material generally used for a mask in the art may be used as the material of the outer skin 110 without limitation.

The outer skin 110 may be a woven fabric or knitted fabric fabricated by weaving or knitting.

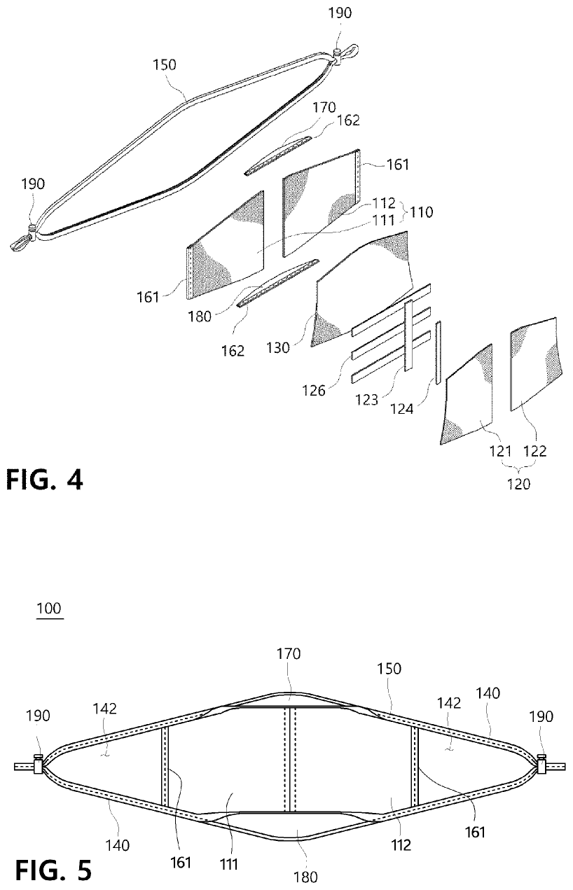

In addition, the outer skin 110 may be formed as one member having an area capable of covering the mouth, the nose, and portions of the cheeks of the user's face, and as illustrated in FIGS. 4 and 5, the outer skin 110 may include a first outer skin 111 and a second outer skin 112 each having a plate shape and a predetermined area, and the first outer skin 111 and the second outer skin 112 may be formed by integrally forming one end portions thereof through sewing.

In this case, the other end portions of the first outer skin 111 and the second outer skin 112 may have separate finishing members 161 having elasticity and flexibility to improve wearing comfort and close contact with the user's face as illustrated in FIG. 5. As an example, the finishing members 161 may be known woven fabric bands having elasticity and flexibility.

The inner skin 120 may be a part which is in close contact with the user's face when worn.

To this end, the inner skin 120 may be disposed on an inner surface of the outer skin 110, and a part of the inner skin 120 may be fixed to the outer skin 110.

Like the outer skin 110 described above, the inner skin 120 may have hydrophobicity, quick-drying, and water-repellent properties in order to prevent generation of bacteria and proliferation of bacteria due to external water, moisture, and the user's saliva.

As an example, the inner skin 120 may be formed of a natural fiber, a synthetic fiber, or the like.

Herein, since a specific content of the natural fiber and the synthetic fiber are the same as those described in the above-described outer skin 110, a detailed description will be omitted.

In addition, any material generally used for a mask in the art may be used as the material of the inner skin 120 without limitation.

Like the outer skin 110, the inner skin 120 may be a woven fabric or knitted fabric fabricated by weaving or knitting.

In this case, the inner skin 120 may be provided to have a smaller area than the outer skin 110, and may be fixed to one surface of the outer skin 110 for an accommodation portion 102 of which one side is open to be formed between one surface of the inner skin 120 facing the outer skin 110 and the outer skin 110 while coming into close contact with the user's face when worn.

As an example, as illustrated in FIG. 2, the inner skin 120 may have the area which may cover the nose and the mouth of the wearer while having the smaller area than the outer skin 110 and may be fixed to the outer skin 110 so that the accommodation portion 102 of which both side portions are open is formed between one surface of the inner skin 120 facing the outer skin 110 and the outer skin 110.

In this case, the filter medium 130 may be inserted into the accommodation portion 102 through an open portion of the accommodation portion 102.

Accordingly, in the mask 100 according to one embodiment of the present invention, when the filter medium 130 inserted into the accommodation portion 102 is contaminated, the filter medium 130 may be withdrawn from the accommodation portion 102 and replaced with an unused product, and the outer skin 110 and the inner skin 120 may be reused after being washed.

As a result, since the mask 100 according to one embodiment of the present invention may be continuously reused by washing the mask 100 and replacing the filter medium 130, waste of resources can be reduced.

In this case, the mask 100 according to one embodiment of the present invention may further include a shape-retaining member 124 embedded in the inner skin 120 to maintain a space generated between the user's mouth and nose by partially maintaining a shape of the inner skin 120 when worn.

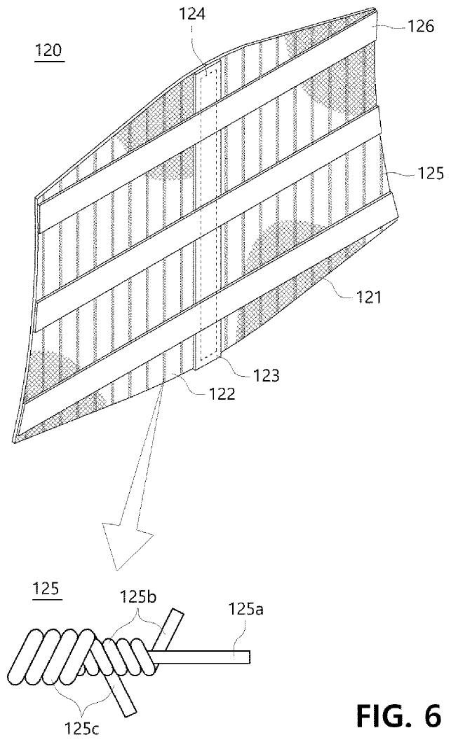

To this end, as illustrated in FIGS. 4 and 6, the inner skin 120 may include a pair of a first inner skin 121 and a second inner skin 122 which are connected to each other through a sewing member 123 and disposed at left and right sides of the sewing member 123, and the shape-retaining member 243 may be embedded in the sewing member 123.

That is, the sewing member 123 may prevent the shape-retaining member 124 from being exposed to the outside while connecting the first inner skin 121 and the second inner skin 122 to each other through sewing.

Herein, the shape-retaining member 124 may be a bar-shaped plate member having a predetermined area or linear wire, and the plate member or linear wire may be bent by an external force and also be restored to its original state by an elastic force.

As an example, the shape-retaining member 124 may be formed of a metal material or a synthetic resin material.

Accordingly, as illustrated in FIG. 1, a central portion of the mask 100 according to one embodiment of the present invention may maintain a streamlined shape in a height direction due to the shape-retaining member 124.

Accordingly, when the mask 100 according to one embodiment of the present invention is worn, the inner skin 120 is not in close contact with the user's philtrum and may maintain a space generated between the user's philtrum and the mask 100, and thus the user can smoothly breathe through the space.

In addition, in the mask 100 according to one embodiment of the present invention, even when the inner skin 120 and the outer skin 110 are washed for reuse, the inner skin 120 in direct contact with the user's face may be restored to its original state due to the shape-retaining member 124. Accordingly, the mask 100 according to one embodiment of the present invention can be reused repeatedly.

However, the coupling method of the inner skin 120 and the shape-retaining member 124 is not limited thereto, the inner skin 120 may be formed of one member having a predetermined area, and the shape-retaining member 124 may be directly embedded in the inner skin 120 or fixed to one surface of the inner skin 120 formed as one member.

In this case, the mask 100 according to one embodiment of the present invention may include a silver yarn to prevent proliferation of bacteria in the inner skin 120, which is in direct contact with the user's face, specifically, with the respiratory system, due to the user's saliva while the mask 100 is being used.

In addition, the inner skin 120 may be formed of a ply yarn 125 to have laundry durability and elasticity while having antibacterial performance due to the silver yarn.

To this end, the inner skin 120 may be a woven fabric including warps and wefts, and at least some of the warps may be formed of the ply yarn 125 including the silver yarn.

That is, as illustrated in FIGS. 4 and 6, the inner skin 120 may be formed as the mesh-type woven fabric including the warps and the wefts, and the warps may be formed of the ply yarn 125 including the silver yarn.

Specifically, as illustrated in the enlarged view of FIG. 6, the ply yarn 125 may include a core yarn 125a having a predetermined length, a first covering yarn 125b including the silver yarn and wound around the core yarn 125a in a longitudinal direction of the core yarn 125a, and a second covering yarn 125c wound around the first covering yarn 125b in the longitudinal direction of the core yarn 125a to surround the first covering yarn 125b.

In this case, any fiber having flexibility and elasticity may be used as the core yarn 125a and the second covering yarn 125c without limitation. Accordingly, the inner skin 120 may have antibacterial performance due to the first covering yarn 125b while having flexibility and elasticity due to the core yarn 125a and the second covering yarn 125c.

Accordingly, the mask 100 according to one embodiment of the present invention can have antibacterial performance due to the first covering yarn 125b while having washing durability and elasticity due to the core yarn 125a and the second covering yarn 125c.

As an example, each of the core yarn 125a and the second covering yarn 125c may be a natural fiber or synthetic fiber. As a non-limiting example, polyester-based fibers may be used as materials of the core yarn 125a and the second covering yarn 125c.

In addition, the core yarn 125a and the second covering yarn 125c may be fibers formed of mono yarn or a plurality of filaments.

In addition, any fiber having a fineness commonly used in the art may be used as the core yarn 125a and the second covering yarn 125c without limitation, and each of the core yarn 125a and the second covering yarn 125c may have a fineness of, preferably, 20 to 100 De and more preferably, 30 to 75 De.

This is because, when the fineness of each of the core yarn 125a and the second covering yarn 125c is less than 20 De, washing durability and antibacterial performance due to a single thread of the silver yarn may be reduced, and when the fineness is greater than 100 De, elasticity may be reduced.

In this case, the second covering yarn 125c may be formed by twisting at a twist level of 350 to 1100 TPM and preferably by twisting at a twist level of 450 to 1000 TPM.

This is because, when the number of twists of the second covering yarn 125c is less than 350 TPM, washing durability and antibacterial performance due to the single thread of the silver yarn may be reduced, and when the number of twists is greater than 1100 TPM, elasticity and flexibility may be reduced, and an exposed area of the silver yarn exposed to the outside may be decreased, which reduces antibacterial performance.

Meanwhile, although the first covering yarn 125b may include the silver yarn as described above, and the silver yarn may be formed of silver alone, the silver yarn may also be a sheath-core fiber.

Herein, the sheath-core fiber may include a copper(Cu)-containing core and a silver(Ag)-containing sheath to improve flexibility.

As an example, the sheath-core fiber may be a fiber formed by drawing a copper material to be used as the core to have a predetermined diameter and then integrating the copper material and a silver plate through a cladding process. Alternatively, the sheath-core fiber may be a fiber formed by drawing a copper material to be used as the core to have a predetermined diameter and then coating a surface of the copper material with silver having a uniform thickness through a dipping process or a plating method.

In this case, an average thickness of the sheath may be in the range of 3 to 3200 nm, and preferably, the average thickness may be in the range of 5 to 3000 nm. This is because, when the average thickness of the sheath is less than 3 nm, there are problems that copper, which is the center metal, may be easily exposed to the outside, and thus inherent functional properties of silver may be degraded, and silver may be detached from the silver yarn and inhaled into the respiratory system of the user. In addition, when the average thickness of the sheath is greater than 3200 nm, flexibility of the silver yarn may be reduced.

Meanwhile, the silver yarn may include the 0.1 to 15 wt % copper and preferably 0.1 to 10 wt % copper and the remaining silver. This is because, when the copper is included in the silver yarn at less than 0.1 wt %, flexibility of the silver yarn may be reduced, and when the copper is included in the silver yarn at greater than 15 wt %, antibacterial performance may be relatively reduced.

In addition, an average fiber diameter of the silver yarn may be in the range of 10 to 60 μm, and preferably the average fiber diameter may be in the range of 15 to 55 μm. In addition, a fineness of the silver yarn may be in the range of 40 to 150 De and preferably in the range of 60 to 120 De. When the average fiber diameter of the silver yarn is less than the above-described range, or the fineness is less than the above-described range, a desired degree of antibacterial effect may not be obtained, and when the average fiber diameter and the fineness of the silver yarn are greater than the above-described ranges, flexibility of the silver yarn may be reduced.

In addition, the first covering yarn 125b may be formed by twisting at a twist level of 550 to 1400 TPM and preferably by twisting at a twist level of 650 to 1300 TPM. When the twist level of the first covering yarn is less than 550 TPM, a desired level of antibacterial performance may not be obtained, and when the twist level is greater than 1400 TPM, elasticity and flexibility of the core yarn 125a and the second covering yarn 125c may be reduced.

However, a structure of the ply yarn 125 is not limited thereto, and the ply yarn 125 may include a core yarn including a silver yarn and a covering yarn wound around the core yarn in a longitudinal direction of the core yarn to surround the core yarn. In addition, the ply yarn 125 may include a core yarn in which a first core yarn and a second core yarn having a silver yarn are combined and a covering yarn wound around the core yarn in a longitudinal direction of the core yarn to surround the core yarn.

In this case, the ply yarn 125 included in the inner skin 120 may be provided in only one surface facing the outer skin 110 to be exposed.

That is, as illustrated in FIGS. 2 and 6, the ply yarn 125 may be exposed to the outside from one surface constituting an inner surface of the accommodation portion 102 without being exposed from one surface in direct contact with the user's face.

Accordingly, the ply yarn 125 can be prevented from being exposed to the outside to prevent deterioration of an aesthetic feeling during use, and a product quality or certification issue due to an exterior defect can be solved.

Meanwhile, the inner skin 120 may further include at least one reinforcement member 126 for maintaining its original shape while securing washing durability even with repeated washing.

That is, the reinforcement member 126 may maintain the original shape of the inner skin 120 with the shape-retaining member 124 described above.

As an example, as illustrated in FIGS. 2 and 6, the reinforcement member 126 may be provided on one surface of the inner skin 120 in a direction intersecting the shape-retaining member 124 and the warps constituting the inner skin 120.

In addition, like the shape-retaining member 124, the reinforcement member 126 may be provided on one surface of the inner skin 120 facing one surface of the outer skin 110 to prevent exposure to the outside during use.

The reinforcement member 126 may be a flexible film member to secure flexibility and also to increase durability. As a non-limiting example, the reinforcement member 126 may be formed of a polymer resin material such as PET or polyurethane (PU).

Accordingly, the inner skin 120 may maintain a shape in a weft direction through the shape-retaining member 124 and maintain a shape in a warp direction through at least one reinforcement member 126.

As a result, in the mask 100 according to one embodiment of the present invention, the inner skin 120 may maintain the original shape through the shape-retaining member 124 and the reinforcement member 126 even when the mask 100 is repeatedly washed for reuse. Accordingly, the mask 100 according to one embodiment of the present invention can maintain a state in which the inner skin 120 is in close contact with the user's face during use.

The filter medium 130 may be inserted into the accommodation portion 102 formed between the outer skin 110 and the inner skin 120 as described above.

The filter medium 130 may prevent droplets or foreign matter from being inhaled into the respiratory system of the user by filtering the droplets and the foreign matter included in the air during the user's breathing.

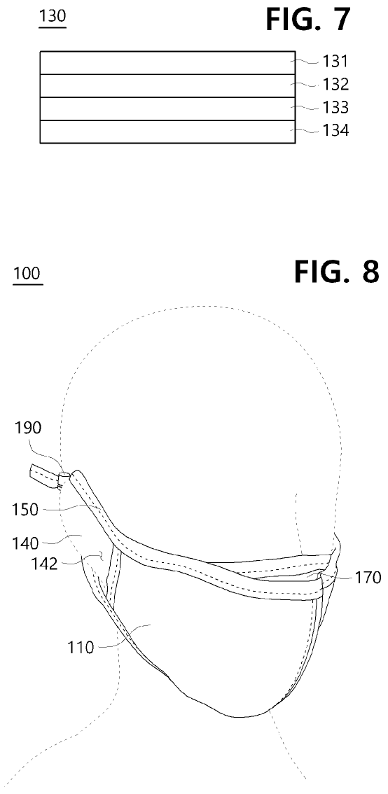

As an example, as illustrated in FIG. 7, the filter medium 130 may include a first support 131, a second support 132, and a nanofiber web 133, and the filter medium 130 may be a laminate in which the first support 131, the second support 132, and the nanofiber web 133 are sequentially stacked on each other.

In this case, the first support 131 and the second support 132 may be porous substrates, and the nanofiber web 133 may be formed by randomly stacking nanofibers in a three-dimensional network structure.

Specifically, the first support 131 may serve as a support and may optionally serve to allow and/or improve a water-repellent/oil-repellent property.

To this end, the first support 131 may be a nonwoven fabric, preferably a dry nonwoven fabric such as a chemical bond nonwoven fabric, a thermal bond nonwoven fabric, or an airlay nonwoven fabric, a wet nonwoven fabric, a spanless nonwoven fabric, a needle punch nonwoven fabric, a spunbond nonwoven fabric, or a meltblown nonwoven fabric, and more preferably the spunbond nonwoven fabric.

A synthetic polymer component selected from the group consisting of polyester-, polyurethane-, polyolefin-, and polyamide-based components or a natural polymer component including a cellulose-based component may be used as a material of the first support 131.

In addition, the first support 131 may be a water-repellent/oil-repellent spunbond nonwoven fabric implemented by spinning a water-repellent/oil-repellent, the polymer described above, and a spinning solution including a water-repellent/oil-repellent or performing a predetermined water-repellent/oil-repellent treatment in order to provide a water-repellent/oil-repellent property.

The second support 132 may serve to improve filtration efficiency. To this end, the second support 132 may include an electrostatically treated portion.

As an example, like the first support 131, the second support 132 may be a nonwoven fabric, preferably a dry nonwoven fabric such as a chemical bond nonwoven fabric, a thermal bond nonwoven fabric, or an airlay nonwoven fabric, a wet nonwoven fabric, a spanless nonwoven fabric, a needle punch nonwoven fabric, or a meltblown nonwoven fabric, and more preferably the meltblown nonwoven fabric.

Herein, the meltblown nonwoven fabric may be a known meltblown nonwoven fabric.

A synthetic polymer component selected from the group consisting of polyester-, polyurethane-, polyolefin-, and polyamide-based components or a natural polymer component including a cellulose-based component may be used as a material of the second support 132.

The nanofiber web 133 may be responsible for physical filtration of a treatment target fluid and preferably treatment target air.

In addition, the nanofiber web 133 may be a water-repellent/oil-repellent nanofiber web, and the water-repellent/oil-repellent nanofiber web may be formed by coating a surface of a nanofiber web with a water-repellent/oil-repellent, or spinning a spinning solution including a polymer resin and a water-repellent/oil-repellent.

Preferably, the water-repellent/oil-repellent nanofiber web may be formed by spinning the spinning solution including the polymer resin and the water-repellent/oil-repellent.

Herein, any polymer resin generally used to form a nanofiber in the art may be used as the polymer resin without limitation. As an example, the polymer resin may include a fluorine-based compound, preferably one or more compounds selected from the group consisting of a polytetrafluoroethylene (PTFE)-based compound, a tetrafluoroethylene-perfluoroalkyl vinyl ether copolymer (PFA)-based compound, a tetrafluoroethylene-hexafluoropropylene copolymer (FEP)-based compound, a tetrafluoroethylene-hexafluoropropylene-perfluoroalkyl vinyl ether copolymer (EPE)-based compound, a tetrafluoroethylene-ethylene copolymer (ETFE)-based compound, a polychlorotrifluoroethylene (PCTFE)-based compound, a chlorotrifluoroethylene-ethylene copolymer (ECTFE)-base compound, a polyvinylidene fluoride (PVDF)-based compound, and more preferably, PVDF.

In this case, when the polymer resin includes the PVDF, a weight average molecular weight of the PVDF may be in the range of 10,000 to 1,000,000 and preferably in the range of 300,000 to 600,000, but is not limited thereto.

In addition, any water-repellent/oil-repellent generally used in the art may be used as the water-repellent/oil-repellent without limitation, and preferably, the water-repellent/oil-repellent may be a solvent type water-repellent/oil-repellent and more preferably a fluorine-based solvent type water-repellent/oil-repellent.

As described above, since the filter medium 130 includes both the second support 132 and the nanofiber web 133, even when efficiency of the electrostatically treated second support 132 is reduced, the filter medium 130 can be prevented from reduction of filtration efficiency through the nanofiber web 133.

Meanwhile, the filter medium 130 may further include a third support 134 attached to one surface of the nanofiber web 133. The third support 134 may serve to bond the nanofiber web 133 and another support in a case in which the filter medium 130 additionally includes another support (not shown) which serves to reinforce a strength of the filter medium 130 or prevent moisture permeability.

As an example, the third support 134 may be a nonwoven fabric, preferably a dry nonwoven fabric such as a chemical bond nonwoven fabric, a thermal bond nonwoven fabric, or an airlay nonwoven fabric, a wet nonwoven fabric, a spanless nonwoven fabric, a needle punch nonwoven fabric, or a meltblown nonwoven fabric, and more preferably the thermal bond nonwoven fabric.

Herein, a synthetic polymer component selected from the group consisting of polyester-, polyurethane-, polyolefin-, and polyamide-based components or a natural polymer component including a cellulose-based component may be used as a material of the third support 134.

As another example, the third support 134 may be manufactured of a composite fiber including a low melting point component. The composite fiber may include a support component and a low melting point component, and at least a part of the low melting point component may be disposed in an outer surface to be exposed.

As a non-limiting example, the composite fiber may also be a sheath-core type composite fiber in which the support component constitutes a core portion and the low melting point component constitutes a sheath portion surrounding the core portion or may be a side-by-side composite fiber in which the low melting point component is disposed at one side of the support component.

The third support 134 may be thermally bonded to the nanofiber web 133 described above.

Meanwhile, the filter medium 130 may further include a fourth support. The fourth support, which is a porous member, may serve to reinforce the filter medium such as reinforcing a strength of the filter medium or preventing moisture permeability.

The fourth support may be disposed on one surface of the first support, one surface of the third support, or between two adjacent members among the first support, the second support, the nanofiber web, and the third support.

The fourth support may be a nonwoven fabric and preferably a dry nonwoven fabric such as a chemical bond nonwoven fabric, a thermal bond nonwoven fabric, or an airlay nonwoven fabric, a wet nonwoven fabric, a spanless nonwoven fabric, a needle punch nonwoven fabric, or a meltblown nonwoven fabric, but is not limited thereto.

However, a structure of the filter medium 130 which may be applied to the mask 100 according to one embodiment of the present invention is not limited thereto, and any known filter member capable of removing foreign matter such as droplets or dust in the air may be applied as the filter medium 130.

As illustrated in FIG. 8, the wearing portion 140 may be provided at both side portions of the outer skin 110 for the mask 100 to be worn on the user's ears when the mask 100 according to one embodiment of the present invention is used.

The wearing portion 140 may be provided as a separate member at both side portions of the outer skin 110, but may be formed using an edge member 150 which fixes the outer skin 110 and the inner skin 120.

That is, as illustrated in FIG. 4, the edge member 150 may be formed in a loop shape, and a partial length of a total length of the edge member 150 may be sewn along an edge of the outer skin 110.

In this case, a portion of the edge member 150 which is sewn along the edge of the outer skin 110 may be sewn to an edge of the outer skin 110 and an edge of the inner skin 120 together.

As an example, an upper edge and a lower edge of the inner skin 120 may be sewn to an edge of the outer skin 110 with the edge member 150.

Accordingly, the inner skin 120 may be fixed to the outer skin 110 for the accommodation portion 102 of which both side portions are open to be formed between one surface of the inner skin 120 and one surface of the outer skin 110 which face each other as described above.

In this case, as illustrated in FIGS. 1 to 3, the wearing portion 140 may be a portion of the edge member 150, which fixes the outer skin 110 and the inner skin 120 to each other, that extends outward from the outer skin 110 to form an opening 104.

Accordingly, in the mask 100 according to one embodiment of the present invention, since the wearing portion 140 may be formed on both side portions of the outer skin 110 through a single sewing operation for fixing the outer skin 110 and the inner skin 120, a production yield can be increased.

In this case, the edge member 150 may be formed of a material having elasticity and flexibility to improve wearing comfort and close contact with the user's face when worn. As an example, the edge member 150 may be a known woven fabric band having elasticity and flexibility.

Meanwhile, the mask 100 according to one embodiment of the present invention may further include a nose rest member 170 and a jaw rest member 180 for preventing outside air from being introduced or inside air from being discharged through a portion other than the inner skin 120 and the outer skin 110 when the user breathes.

That is, as illustrated in FIGS. 1 to 3, the nose rest member 170 may be provided to extend outward from an upper portion of the outer skin 110, and the jaw rest member 180 may be provided to extend outward from a lower portion of the outer skin 110.

In this case, finishing members 162 having elasticity and flexibility may be provided on free end portions of the nose rest member 170 and the jaw rest member 180 to improve wearing comfort and close contact with the user's face when worn. As an example, the finishing members 162 may be a known woven fabric band having elasticity and flexibility.

Accordingly, when worn, the free end portion of the nose rest member 170 may be in close contact with the user's nose due to the finishing member 162, and the free end portion of the jaw rest member 180 may be in close contact with the user's jaw due to the finishing member 162.

Accordingly, the mask 100 according to one embodiment of the present invention may block outside air from being introduced or inside air discharged from the respiratory system of the user from being discharged to the outside through a portion other than a portion corresponding to the inner skin 120 when the user breathes.

Each of the nose rest member 170 and the jaw rest member 180 may be formed of the same material as the above-described outer skin 110 and may be fixed to the outer skin 110 through the edge member 150 which fixes the inner skin 120 and the outer skin 110.

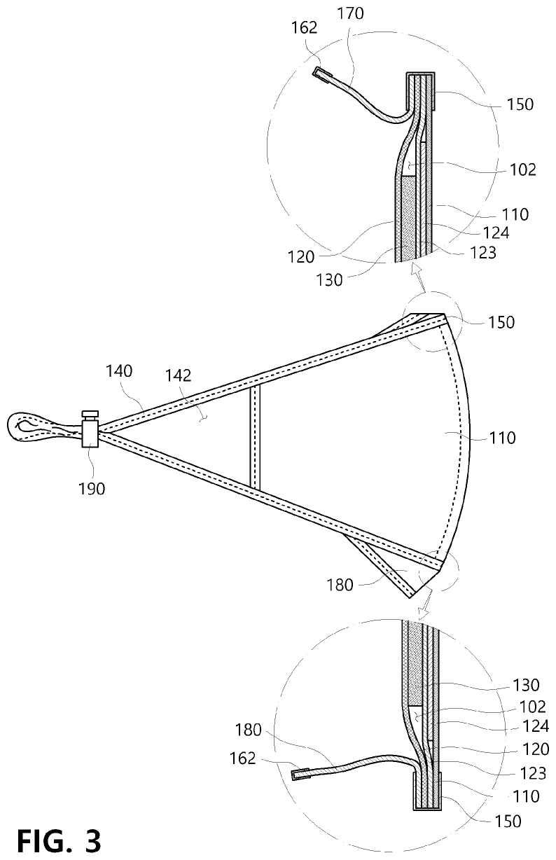

In this case, in the mask 100 according to one embodiment of the present invention, the jaw rest member 180 may be provided to have a larger area than the nose rest member 170 as illustrated in FIG. 3.

Accordingly, when the user wears the mask 100 according to one embodiment of the present invention, an area of the jaw covered by the jaw rest member 180 may be greater than an area of the nose covered by the nose rest member 170 on the user's face.

As a result, when the user wears the mask 100 according to one embodiment of the present invention, the jaw rest member 180 may cover a wide area of the jaw of the user so that the entire mask 100 is stably worn on the user's face. Accordingly, the jaw rest member 180 may prevent the mask 100 from being separated from the user's face and increase the user's wearing comfort.

Meanwhile, the mask 100 according to one embodiment of the present invention may further include a length adjustment member 190 for adjusting a length of the wearing portion 140.

The length adjustment member 190 may be coupled to the wearing portion 140 as illustrated in FIG. 1.

As an example, the length adjustment member 190 may be a stopper type member which allows movement of the edge member 150 constituting the wearing portion 140 during the user's press operation and restricts the movement of the edge member 150 when a pressing state is released.

Accordingly, the user may appropriately adjust the length of the wearing portion 140 according to his or her body size by manipulating the length adjustment member 190.

However, the length adjustment member 190 is not limited thereto, and any known method through which a size of the opening 104 can be adjusted may be applied to the length adjustment member 190.

While some embodiments of the present invention have been described above, the spirit of the present invention is not limited to the embodiments proposed in this specification, and other embodiments may be easily suggested by adding, changing, and removing components within the scope of the invention by those skilled in the art and will fall within the conceptual range of the present invention.

1. A mask comprising:
an outer skin which constitutes an outer exposed surface when the mask is worn;
an inner skin which is in contact with the face of a user and is fixed to one surface of the outer skin so that an accommodation portion of which at least one side is open is formed between one surface of the inner skin facing the outer skin and the outer skin;
a filter medium accommodated in the accommodation portion; and
a wearing portion provided at each of both side portions of the outer skin for the mask to be worn on ears of the user.

2. The mask of claim 1, further comprising a shape-retaining member embedded in a sewing member so that a space between a mouth and a nose of the user is maintained by maintaining a shape of the sewing member when the mask is worn,
wherein the inner skin includes a pair of a first inner skin and a second inner skin connected to each other through the sewing member and disposed at both of a left side and a right side of the sewing member.

3. The mask of claim 2, wherein:
the shape-retaining member includes a plate member or linear wire; and
the plate member or linear wire is formed of a metal material or synthetic resin material.

4. The mask of claim 1, wherein:
the inner skin includes a woven fabric having a warp and a weft;
at least a part of the warp is a ply yarn including a silver yarn; and
the ply yarn is provided in one surface of the inner skin facing the outer skin to be exposed.

5. The mask of claim 4, wherein the ply yarn includes:
a core yarn;
a first covering yarn including a silver yarn and wound around the core yarn in a longitudinal direction of the core yarn; and
a second covering yarn wound around the first covering yarn in the longitudinal direction of the core yarn to surround the first covering yarn.

6. The mask of claim 5, wherein each of the core yarn and the second covering yarn includes a natural fiber or synthetic fiber.

7. The mask of claim 4, wherein:
the inner skin includes at least one reinforcement member fixed to one surface of the inner skin facing the outer skin; and
the at least one reinforcement member is disposed to intersect the warp to maintain an original shape of the inner skin.

8. The mask of claim 4, wherein the silver yarn includes a sheath-core fiber having a core including copper and a sheath including silver and surrounding the core.

9. The mask of claim 1, further comprising an edge member sealed along an edge of the outer skin,
wherein the edge member includes a band member having elasticity and flexibility.

10. The mask of claim 9, wherein the wearing portion is formed by extending a part of the edge member outwardly from the outer skin.

11. The mask of claim 9, wherein the inner skin is fixed to the outer skin through the edge member.

12. The mask of claim 1, further comprising:
a nose rest member extending from the outer skin to be in close contact with the nose of the user when the mask is worn; and
a jaw rest member extending from the outer skin to be in close contact with the jaw of the user when the mask is worn,
wherein the jaw rest member is provided to have a larger area than the nose rest member.

13. The mask of claim 1, wherein the filter medium has a form in which a first support which is porous, a second support which is porous, and a nanofiber web are sequentially stacked.

14. The mask of claim 13, wherein:
the first support includes a spunbond nonwoven fabric; and
the second support includes a meltblown nonwoven fabric.

15. The mask of claim 13, wherein:
the first support is a water-repellent/oil-repellent spunbond nonwoven fabric; and
the nanofiber web is a water-repellent/oil-repellent nanofiber web.

16. The mask of claim 13, wherein the second support includes an electrostatically treated portion.
